(19) United States
(12) Patent Application Publication
(10) Pub. No.: US 2007/0000398 A1
(43) Pub. Date: Jan. 4, 2007

(54) Device for making stuffed tofu and the method for making stuffed tofu by using the same

(76) Inventor: Kung-Shen Lo, Taipei Hsien (TW)

Correspondence Address: KUNG-SHEN LO, 235 Chung - Ho, Box 8-24, Taipei, TW

(21) Appl. No.: 11/516,451

(22) Filed: Sep. 7, 2006

Related U.S. Application Data
(63) Continuation-in-part of application No. 10/891,158, filed on Jul. 13, 2004, now abandoned.

(51) Int. Cl. A23B 4/02

(52) U.S. Cl. 99/494

(57) ABSTRACT

A device for making stuffed tofu has a bar to hold the stuffed material and a container with a compartment. The compartment has a recess to position the bar. The compartment has a volume larger than a volume of the stuffed material. The method for making stuffed tofu has steps of positioning a stuffed material onto a bar, placing the bar with the stuffed material in the recess in the compartment of the container, immersing soybean in water for 8-12 hours and grinding the immersed soybean, adding 4-6 times of water relative to the volume of the soybean to the ground soybean to become soybean magma, boiling the soybean magma for 3-5 minutes, cooling the soybean and then adding condensate to become lactary soybean, and inputting the lactary soybean into the compartment in the container to surround the stuffed material.

The invention is a continuation in part (CIP) of U.S. Pat. No. 10,891,158 assigned and invented to the inventor of the present invention, and thus the content of the application is incorporated into the present invention as a part of the present invention.

### BACKGROUND OF THE INVENTION

1. Field of the Invention

The present invention relates to a method for making stuffed tofu and the device thereof, and more particularly to a method for making stuffed tofu, which is able to secure the stuffed material inside the tofu. The device for performing the method comprises at least one bar for holding thereon a material to be stuffed inside the tofu, a container with at least one compartment defined therein to receive and position the bar with the ready-to-stuffed material and a cover for covering the container.

2. Description of Related Art

Normally, when a material is to be stuffed inside a food, the user slides a slit in the food and then inserts the material into the food for cooking. However, when the stuffed food is cooking, chances that the stuffed material may fall out of the food might happen, which causes a lot of trouble for the user. Especially, the stuffed material after falling out of the food may stain the pot and spoil the entire dish.

In order to overcome the shortcoming, inventions have been implemented by using sophisticated machine to ensure that the stuffed material is not falling out of the food when cooking. However, all these improvements only suitable for large scale machine for mass production and require a lot of investment, which are all not suitable for making stuffed tofu.

To overcome the shortcomings, the present invention intends to provide an improved method for making stuffed tofu and the device thereof to mitigate or obviate the aforementioned problems.

### SUMMARY OF THE INVENTION

The primary objective of the invention is to provide a method for making stuffed tofu.

In order to accomplish the objective, the method comprises steps of positioning a stuffed material onto a bar in such a manner that both ends of the bar are still able for holding, placing the bar with the stuffed material in the recess in the compartment of the container, immersing soybean in water for 8-12 hours and grinding the immersed soybean, adding 4-6 times of water relative to the volume of the soybean to the ground soybean to become soybean magma, boiling the soybean magma for 3-5 minutes, cooling the soybean and then adding condensate to become lactary soybean, and inputting the lactary soybean into the compartment in the container to surround the stuffed material.

Another objective of the invention is to provide a device for making stuffed tofu comprises at least one bar, a container with a recess defined in a bottom face of the container for positioning the bar and a cover for covering the container.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the device for making stuffed tofu of the present invention;

FIG. 2 is a perspective view of the container of the device in FIG. 1, wherein the container is reversed for clear observation;

FIG. 3 is a schematic view showing that the bars are provided with stuffed material and ready to be placed in compartments in the container;

FIG. 4 is a schematic view showing that the bars are placed inside the container;

FIG. 5 is a schematic view showing that lactary soybean is poured in each of the compartments in the container;

FIG. 6 is a schematic view showing that the lactary soybean surrounds the stuffed material and is cooled down to solidify the lactary soybean;

FIG. 7 is a perspective view of the device with a cover;

FIG. 8 is an exploded perspective view of a second embodiment of the present invention;

FIG. 9 is a schematic view showing that the bar of the second embodiment is provided with the stuffed material;

FIG. 10 is a schematic view showing that the bar with the stuffed material is placed inside the container of the second embodiment;

FIG. 11 is a schematic view showing that the lactary soybean is poured into the container of the second embodiment;

FIG. 12 is a schematic view showing that the lactary soybean surrounds the stuffed material and is cooled down to solidify the lactary soybean;

FIG. 13 is a perspective view showing another embodiment of the present invention, wherein the container is shaped like a fish to indicate the ingredient of the tofu made; and

FIG. 14 is a perspective view showing still another embodiment of the present invention, wherein the container is shaped like a cow to indicate the ingredient of the tofu made.

### DETAILED DESCRIPTION OF PREFERRED EMBODIMENT

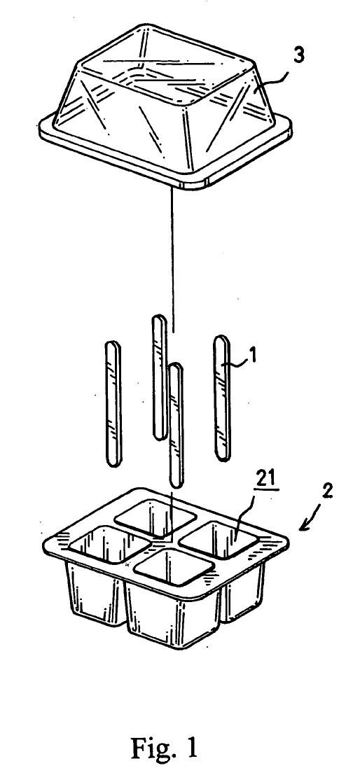

With reference to FIG. 1, the device for accomplishing the objective of the present invention comprises at least one bar 1, a container 2 with at least one compartment 21 defined therein and a cover 3 for detachably engaging with the container 2.

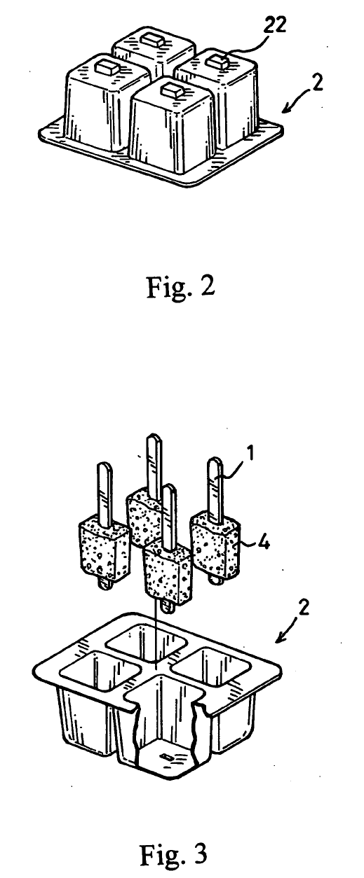

With reference to FIGS. 2 and 3, the at least one compartment 21 has a recess 22 defined in a bottom face defining the compartment 21 to correspond to one of the bars 1. When making the stuffed tofu, it is first necessary to use any method well known in the art to securely attach a stuffed material 4 onto the at least one bar 1. It is to be noted that when the stuffed material 4 is attached to the at least one bar 1, both ends of the at least one bar 1 is left with an appropriate length so that after the stuffed tofu is made, the user is able to hole either end of the bar 1.

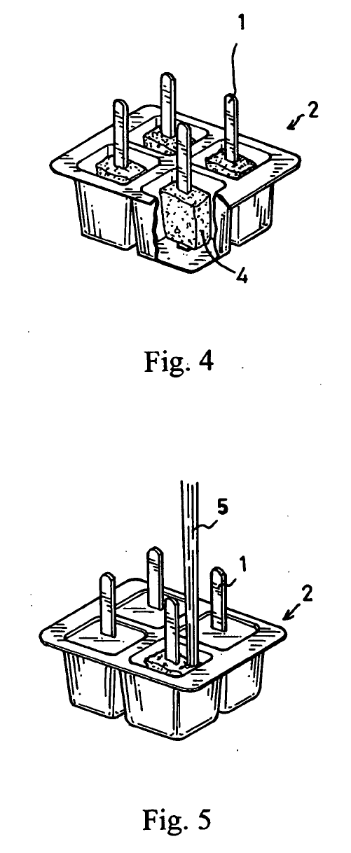

After the stuffed material 4 is securely attached to the at least one bar 1, the user places the at least one bar 1 in the at least one compartment 21 by inserting one of the distal ends of the at least one bar 1 into the recess 22 defined in the at least one compartment 21 of the container 2. However, it should be noted that when the stuffed material 4 is made and attached to the at least one bar 1, the size of the stuffed material 4 is smaller than a volume of the at least one compartment 21 so that after the at least one bar 1 with the stuffed material 4 attached thereon is placed inside the compartment 21, there is still room left in the at least one compartment 21, as shown in FIG. 4.

Thereafter, the user prepares a suitable quantity of soybean and immerses the soybean in the water for 8-12 hours. The soybean is then removed and ground. After the soybean is ground, the user adds 4-6 times of water relative to the volume of the ground soybean to make soybean magma. The soybean magma is boiled for 3 to 5 minutes. After filtering and cooling process to the boiled soybean magma, condensate is added to the soybean magma to make lactary soybean 5.

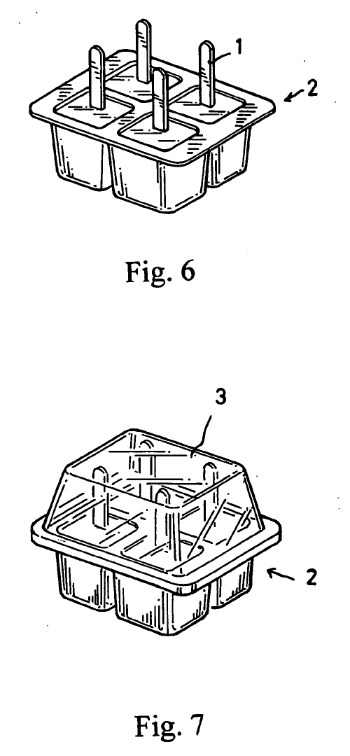

With reference to FIG. 5, after the lactary soybean 5 is made, the user pours the lactary soybean 5 into the at least one compartment 21 with the at least one bar 1 inserted into the recess 22 and the stuffed material 4 securely attached to the at least one bar 1. After the lactary soybean 5 is poured into the at least one compartment 21 and the condensate is added into the at least one compartment 21, the lactary soybean 5 surrounds the at least one bar 1 and the stuffed material 4. Then, after solidification of the lactary soybean 5, the stuffed tofu is made, as shown in FIG. 6.

When the stuffed tofu is made, the cover 3 is engaged with the container 2. Thus, the stuffed tofu is ready for use. When the stuffed tofu is eaten, the user removes the cover 3 and holds the free end of the at least one bar 1 to remove the at least one bar 1 with the tofu and the stuffed material 4 inside the tofu. After a proper cooking process, the stuffed tofu is edible.

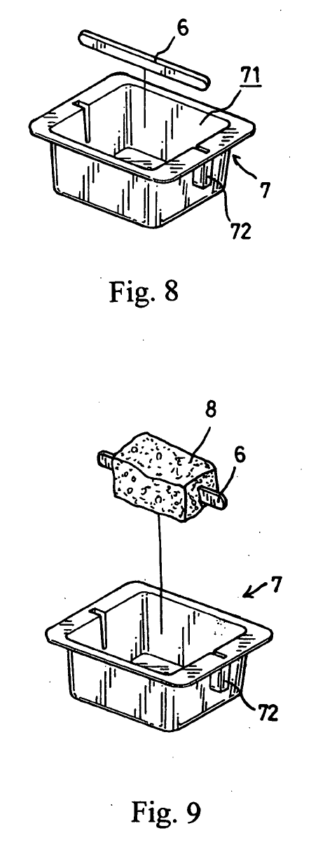

With reference to FIG. 8, the device of the second embodiment comprises at least one bar 6 (only one is shown), a container 7 with at least one compartment 71 (one 11 is shown) defined therein and a pair of recesses 72 oppositely defined in a side face defining the compartment 71 to correspond to the bar 6.

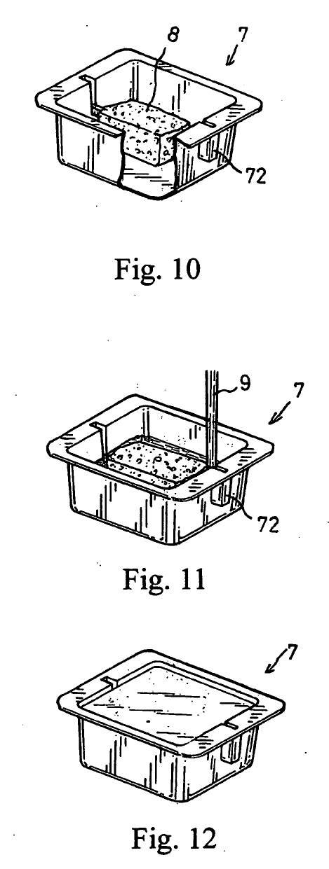

With reference to FIGS. 9 and 10, when making the stuffed tofu, it is first necessary to use any method well known in the art to securely attach a stuffed material 8 onto the bar 6. It is to be noted that when the stuffed material 8 is attached to the bar 6, both ends of the bar 6 is left with an appropriate length so that after the stuffed tofu is made, the user is able to hole either end of the bar 6.

After the stuffed material 8 is securely attached to the bar 6, the user places the bar 6 in the compartment 71 by inserting the distal ends of bar 6 into the recesses 72 defined in the compartment 71 of the container 7. However, it should be noted that when the stuffed material 8 is made and attached to the bar 6, the size of the stuffed material 8 is smaller than a volume of the compartment 71 so that after the bar 6 with the stuffed material 8 attached thereon is placed inside the compartment 71, there is still room left in the compartment 71, as shown in FIG. 10.

Thereafter, the user prepares a suitable quantity of soybean and immerses the soybean in the water for 8-12 hours. The soybean is then removed and ground. After the soybean is ground, the user adds 4-6 times of water relative to the volume of the ground soybean to make soybean magma. The soybean magma is boiled for 3 to 5 minutes. After filtering and cooling process to the boiled soybean magma, condensate is added to the soybean magma to make lactary soybean 9.

With reference to FIG. 11, after the lactary soybean 9 is made, the user pours the lactary soybean 9 into the compartment 71 with the bar 6 inserted into the recesses 72 and the stuffed material 8 securely attached to the bar 6. After the lactary soybean 9 is poured into the compartment 71 and the condensate is added into the compartment 71, the lactary soybean 9 surrounds the bar 6 and the stuffed material 8. Then, after solidification of the lactary soybean 9, the stuffed tofu is made, as shown in FIG. 12.

When the stuffed tofu is made, the cover (not shown in this embodiment) is engaged with the container 7. Thus, the stuffed tofu is ready for use. When the stuffed tofu is eaten, the user removes the cover and reverses the container 7 with the tofu and the stuffed material 8 inside the tofu. After a proper cooking process, the stuffed tofu is edible.

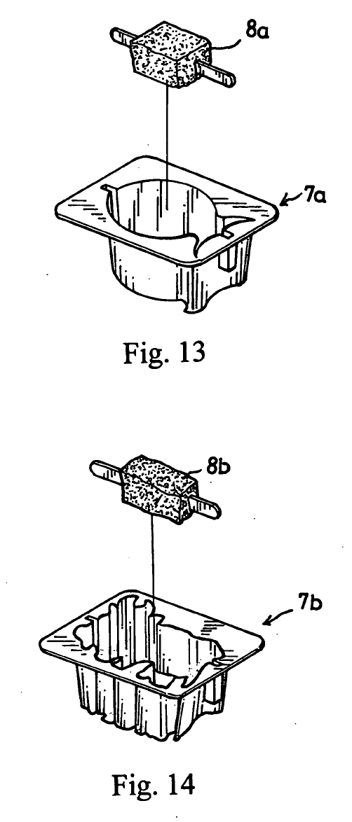

To distinguish the ingredient of the stuffed tofu, the shape of the compartment 2,7 may be made like a fish 7a, as shown in FIG. 13, or a cow 7b, as shown in FIG. 14, so that the user is able to tell each one from the other ones.

It is to be noted that the method and the device applied to the method have the following advantages.

1. Minimum cost

2. Due to the simple and minimum elements required, the cost is minimum.

3. Easy to operate

4. The structure of the device is simple so that the user is able to readily operate the entire device.

5. Suitable for mass production.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A device for making tofu with stuffed material inside the tofu, the device comprising:
at least one bar adapted to hold the stuffed material on the at least one bar and for holding by the user;
a container with at least one compartment defined in the container, the at least one compartment having a recess defined therein to position the at least one bar inside the at least one compartment, wherein the at least one compartment is configured to have a volume adapted to be larger than a volume of the stuffed material so that after the stuffed material is placed inside the at least one compartment, there is still available room left for addition of lactary soybean.

2. The device as claimed in claim 1, wherein
the container has a rectangular shape; and there are four compartments which are arranged as a 2 by 2 matrix in the container; and each compartment has a recess at a bottom side thereof; each compartment has a rectangular shape and each recesses has a rectangular shape for receiving a distal end of each bar; and the container has a cover for covering upon an upper side f the container; the cover has a rectangular cross section at a transversal side and a trapezoidal cross section at a longitudinal side.

3. The device as claimed in claim 1, wherein there is only compartment and each compartment has two recesses at two opposite sides of the compartment.

4. The device as claimed in claim 3, wherein the compartment has a shape configured like a fish.

5. The device as claimed in claim 3, wherein the compartment has a shape configured like a cow.

6. The device as claimed in claim 1 further comprising a cover engaged with the container.

7. The device as claimed in claim 1, wherein the recess is defined in a bottom face defining the at least one compartment so that a distal end of the at least one bar is able to be inserted into the recess to be positioned in the at least one compartment.

8. The device as claimed in claim 1, wherein the container has a pair of recesses each defined in an opposite side face of the container to correspond to both distal ends of the at least one bar.

9. A method for making stuffed tofu, the method comprising the steps of:
positioning a stuffed material onto a bar in such a manner that both ends of the bar are still able for holding;
placing the bar with the stuffed material in a recess in a compartment of a container;
immersing soybean in water for 8-12 hours;
grinding the immersed soybean;
adding 4-6 times of water relative to the volume of the immersed soybean to the ground soybean to become soybean magma;
boiling the soybean magma for 3-5 minutes;
cooling the soybean magma and then adding condensate to become lactary soybean;
and inputting the lactary soybean into the compartment in the container to surround the stuffed material.

10. The method as claimed in the method as claimed in claim 9, the device comprising: at least one bar adapted to hold the stuffed material on the at least one bar and for holding by the user; the container with at least one compartment defined in the container, the at least one compartment having a recess defined therein to position the at least one bar inside the at least one compartment, wherein the at least one compartment is configured to have a volume adapted to be larger than a volume of the stuffed material so that after the stuffed material is placed inside the at least one compartment, there is still available room left for addition of lactary soybean.

11. The device as claimed in claim 10 further comprising a cover engaged with the container.

12. The device as claimed in claim 10, wherein the recess is defined in a bottom face defining the at least one compartment so that a distal end of the at least one bar is able to be inserted into the recess to be positioned in the at least one compartment.

13. The device as claimed in claim 10, wherein the container has a pair of recesses each defined in an opposite side face of the container to correspond to both distal ends of the at least one bar.

14. The device as claimed in claim 10, wherein the at least one compartment has a shape configured like a fish.

15. The device as claimed in claim 10, wherein the at least one compartment has a shape configured like a cow.
